(19) United States
(12) Patent Application Publication
(10) Pub. No.: US 2004/0195359 A1
(43) Pub. Date: Oct. 7, 2004

(54) Fluid distributing apparatus

(76) Inventor: Harold D. Curtis, Oklahoma City, OK (US)

Correspondence Address: DUNLAP, CODDING & ROGERS P.C., PO BOX 16370, OKLAHOMA CITY, OK, 73113, US

(21) Appl. No.: 10/800,964

(22) Filed: Mar. 15, 2004

Related U.S. Application Data
(60) Provisional application No. 60/454,440, filed on Mar. 13, 2003.
(60) Provisional application No. 60/541,333, filed on Feb. 3, 2004.

(51) Int. Cl. B05B 3/02

(52) U.S. Cl. 239/214

(57) ABSTRACT

A fluid distributing apparatus is disclosed. The fluid distributing apparatus includes an orifice housing defining a first surface, a deflector plate defining a second surface spaced apart from the first surface to define an annular nozzle opening therebetween, and a turbine located between the first and second surfaces and freely rotatable between the first and second surfaces. The turbine has a plurality of radially extending fins each having leading edge, a trailing edge, and a radial surface for directing the flow of fluid exiting the nozzle opening. At least a first one of the fins has a vane extending at an angle relative to the radial surface so as to redirect the flow of fluid passing along the radial surface of the fin.

### CROSS-REFERENCE TO RELATED APPLICATIONS

This application claims the benefit of U.S. Provisional Application Serial No. 60/454,440, filed Mar. 13, 2003, and U.S. Provisional Application Serial No. 60/541,333, filed Feb. 3, 2004, the contents of each being hereby incorporated herein by reference.

### BACKGROUND OF THE INVENTION

1. Field of the Invention

The present invention relates generally to a fluid distributing apparatus, and more particularly, but not by way of limitation, to an improved fluid distributing apparatus for uniformly distributing a liquid over a predetermined area.

2. Brief Description of the Background Art

Cooling towers typically utilize a grid work of overhead nozzles to form a plurality of overlapping spray patterns for the purpose of distributing water over the upper surface of a layer of fill material through which air is drawn. The water flows downward through the fill material as the air flows upward through or across the fill material whereby the heat of the water is transferred to the air.

It is important to obtain as uniform a distribution as possible of the water over the upper surface of the fill material so that the water will uniformly flow through the fill material across the entire cross-sectional area of the tower. If the water distribution is not uniform, channels will develop which are substantially void of water and which thus provide a low pressure path through which the air will channel, thus greatly reducing the efficiency of the heat exchange operation conducted by the cooling tower.

It been found that the efficiency of the heat exchange operation is greatly increased by using fluid distributing devices or nozzles that will create a plurality of abutting or overlapping square spray patterns, such as that disclosed in U.S. Pat. No. 5,152,458, the entire contents of which are hereby incorporated herein by reference. The formation of square spray patterns enables the spray patterns to be mated with each other so that voids or gaps do not exists between adjacent spray patterns. However, inefficiencies may still occur if the fluid distributed by each nozzle is not distributed uniformly across each of the individual square spray patterns. That is, the voids that result in low pressure channels may not exists at the perimeter of the spray patterns, but instead may be created within the boundaries of the spray pattern if the fluid is distributed in a non-uniform manner across the square spray pattern.

To this end, a need exists for a fluid distribution apparatus which produces a square spray pattern and which distributes fluid in a substantially uniform volume across the entirety of the square spray pattern. It is to such a fluid distribution apparatus that the present invention is directed.

### DESCRIPTION OF THE SEVERAL VIEWS OF THE DRAWINGS

FIG. 1 is an exploded, perspective view of a fluid distribution apparatus constructed in accordance with the present invention.

FIG. 2 is a sectional view of a fluid distribution apparatus of the present invention.

FIG. 3 is a bottom plan view of a turbine.

FIG. 4 is a top plan view of the turbine of FIG. 3.

FIG. 5A is a profile view of a fin. FIG. 5B is an end view taken along line 5B-5B of FIG. 5A.

FIG. 6A is a profile view of a fin. FIG. 6B is an end view taken along line 6B-6B of FIG. 6A.

FIG. 7A is a profile view of a fin. FIG. 7B is an end view taken along line 7B-7B of FIG. 7A.

FIG. 8A is a profile view of a fin. FIG. 8B is an end view taken along line 8B-8B of FIG. 8A.

FIG. 9 is a perspective view of another embodiment of a turbine of the present invention.

FIG. 10 is a bottom plan view of a portion of the turbine of FIG. 9.

FIG. 11 is a partial cross sectional, top plan view of a portion the turbine of FIG. 9.

### DETAILED DESCRIPTION OF THE INVENTION

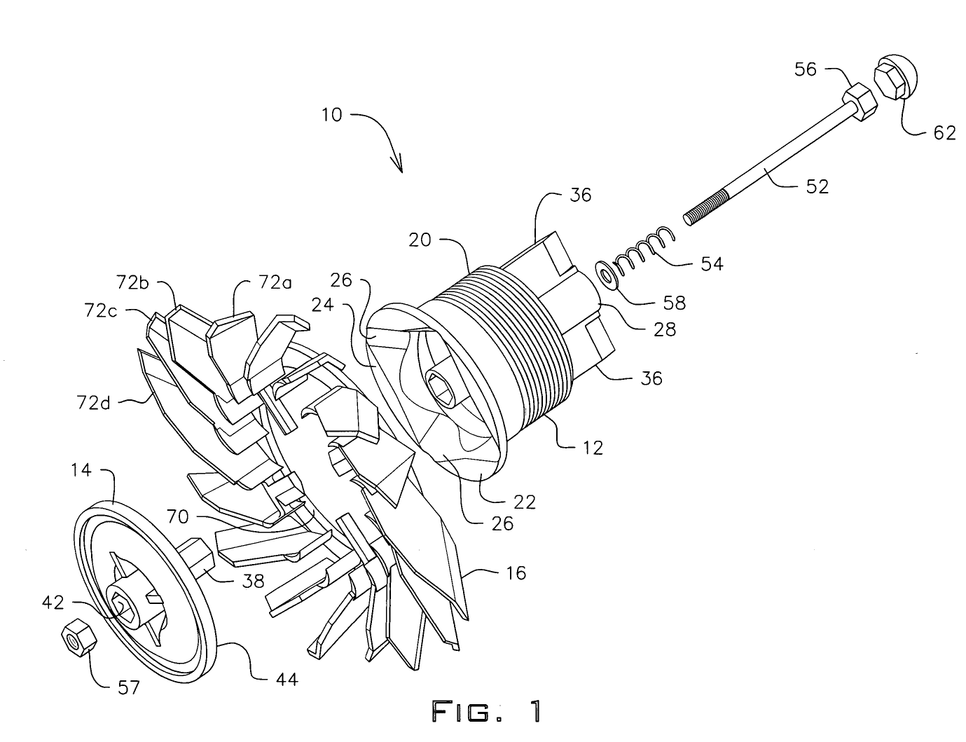

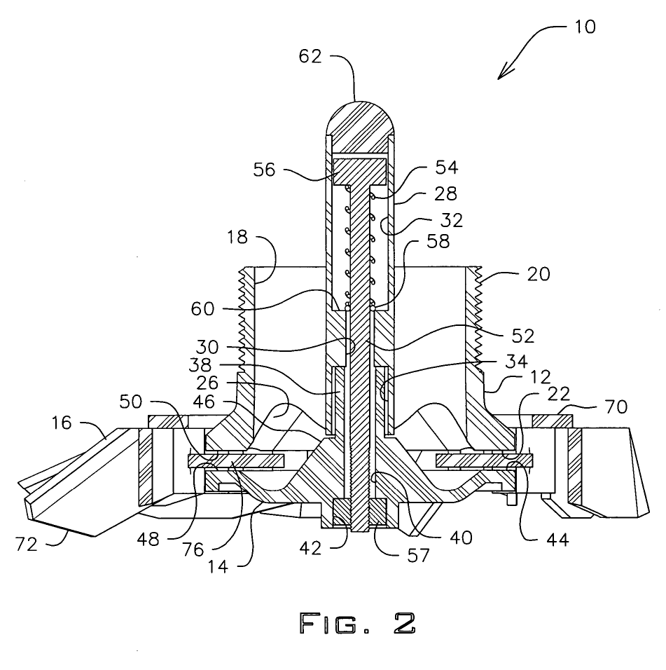

Referring now to the drawings, and more particularly to FIGS. 1 and 2, shown therein is a fluid distributing apparatus 10 constructed in accordance with the present invention. The fluid distribution apparatus 10 includes an orifice housing 12, a deflector plate 14, and a turbine 16.

The orifice housing 12 is a generally tubular member defining a fluid passage 18 (FIG. 2). The orifice housing 12 is provided with a threaded end 20 for connecting the orifice housing 12 to a fluid distributing header (not shown). The other end of the orifice housing 12 is provided with an irregular shaped first annular surface 22.

The irregular shaped first annular surface 22 is an undulating surface having four peaks 24 equally spaced at 90 degree intervals about the circumference of annular surface 22, and having four troughs 26 located between the peaks 24 and also being substantially equally spaced. One of the troughs 26 is located equidistant between each adjacent pair of peaks 24.

As best seen in FIG. 2, the orifice housing 12 is further provided with a central hub 28 having a bore 30 extending therethrough. The bore 30 has an upper spring receiving socket 32 and a lower stem receiving socket 34. The hub 28 is fixed within the fluid passage 18 of the orifice housing 12 with a plurality of radially spaced ribs 36 (FIG. 1). In addition to securing the hub 28 in the orifice housing 12, the ribs 36 guide fluid through the orifice housing 12 so as to prevent vortical fluid flow.

The deflector plate 14 has a stem 38 with a central bore 40. The stem 38 is configured to be slidingly registered in the lower stem receiving bore socket 34 of the orifice housing 12 so that the central bore 40 is axially aligned with the bore 30 of the hub 28 of the orifice housing 12. The central bore 40 further includes a nut receiving socket 42 on a lower end thereof.

The orifice housing 12 and the deflector plate 14 are preferably constructed of a durable polymeric material, such as acetyl.

The deflector plate 14 defines a second annular surface 44. The second annular surface 44 has a frustoconically shaped center hub 46 and peripheral surface 48 which has a substantially planar configuration. The deflector plate 14 is connected to the orifice housing 12 so that the first surface 22 of the orifice housing 12 and the second surface 44 of the deflector plate 14 are spaced apart from one another to define an annular nozzle opening 50 therebetween. Because of the irregular shape of the first surface 22, the spacing between the first surface 22 and the second surface 44 varies around a circumference of the annular nozzle opening 50 to create a non-circular spray pattern of fluid exiting the nozzle opening 50. In particular, a generally square spray pattern will be provided due to the formation of four troughs 26 and four peaks 24. The fluid flowing pass the peaks 24 will define the corners of the square pattern because the peaks 24 cause a flow restriction which increases the pressure of the fluid and thus causes the fluid to flow farther than the fluid flowing pass the troughs 26.

The deflector plate 14 is connected to the orifice housing 12 with a guide rod 52 and a compression spring 54. The guide rod 52 has a head 56 at its upper end which is received in the spring receiving socket 32 along with the compression spring 54 which is disposed about an upper end of the guide rod 52. The remainder of the guide rod 52 extends through the bore 30 of the orifice housing 12 and through the bore 40 of the deflector plate 14 with the stem 38 of the deflector plate 14 positioned in the stem receiving socket 34 of the orifice housing 12. A nut 57 disposed in the nut receiving socket 42 of the deflector plate 14 is secured to a lower threaded end of the guide rod 52 thereby securing the deflector plate 14 to the orifice housing 12.

The slidable mounting of the deflector plate 14 on the orifice housing 12 in combination with the use of the compression spring 54 provides an automatic adjusting mechanism for increasing the spacing between the first and second annular surfaces 22 and 44 in response to an increase in fluid pressure in the annular nozzle opening 50.

The deflector plate 14 is initially connected to the orifice housing 12 with an upper end of the stem 38 of the deflector plate 14 held in abutting engagement with the orifice housing 12. It will be appreciated that when the fluid pressure supplied to the fluid distributing apparatus 10 is increased, that increased fluid pressure will create an increased downward force acting on the deflector plate 14 which will cause the spring 54 to be compressed thus increasing the spacing between annular surfaces 22 and 44. The spring rate of the spring 54 can be adjusted by increasing or decreasing the initial compression applied by nut 57.

The deflector plate 14 is shown in FIG. 2 in an initial position wherein a minimum spacing between the annular surfaces 22 and 44 is defined by the physical dimensions of deflector plate 14 and orifice housing 12. When fluid pressure supplied to the fluid distributing apparatus 10 is increased, the increased downward force acting on the deflector plate 14 will compress the spring 54 to increase the spacing between annular surfaces 22 and 44. As an example, the fluid distributing apparatus 10 will be designed with an initial minimum clearance between surfaces 22 and 24 at the peaks 24 of one-quarter inch. The spring 54 will be chosen to allow a stroke of about one-half inch so that the maximum clearance between surfaces 22 and 44 will be about three-quarters inch.

It will be appreciated that in the absence of the automatic nozzle adjustment provided by the spring 54 and the sliding engagement of deflector plate 14 with the guide rod 52, a substantial increase in fluid supply pressure would cause the spray pattern to be extended radially outward to an undue extent and would tend to create a void in the center of the pattern. Conversely, a decrease in flow supply pressure would cause the spray pattern to be reduced radially inward and would tend to create a void in the outer perimeter of the spray pattern. By appropriate choice of the spring rate of spring 54, the fluid distributing apparatus 10 will automatically adjust the cross-sectional area of annular nozzle opening 50 so as to maintain a substantially uniform spray pattern over a wide range of fluid supply pressures and flow rates.

In addition to supporting the guide rod 52 and the spring 54, the hub 28 of the orifice housing 12 functions as a housing for the spring 54 to isolate the spring 54 from the fluid passing through the orifice housing 12 and exiting the nozzle opening 50. When the spring 54 is in contact with such fluid, the spring has a tendency to become fouled with solids thereby impeding the ability of the spring 54 to react to changes in fluid flow pressure. To isolate the spring 54, a seal member 58, such as an o-ring, is disposed between a lower end of the spring 54 and a shoulder 60 of the hub 28 to provide a fluid tight seal between the guide rod 52 and the shoulder 60 of the hub 28. In addition, a cap 62 is secured to the upper end of the hub 28 thereby enclosing the spring 54 within the spring receiving socket 32 of the hub 28. It will be appreciated by those of ordinary skill in the art that the spring receiving socket 32 could alternatively be formed as a part of the deflector plate 14.

The turbine 16 includes a mounting ring 70 sized to be positioned about the orifice housing 12, a plurality of fins 72 extending circumferentially about a bottom surface 74 of the orifice housing 12, and a plurality of guide tabs 76 extending radially inwardly of the mounting ring 70 for maintaining the fins 72 in an operable relationship with the nozzle opening 50. The turbine 16 is preferably formed of a polymeric material, such as nylon.

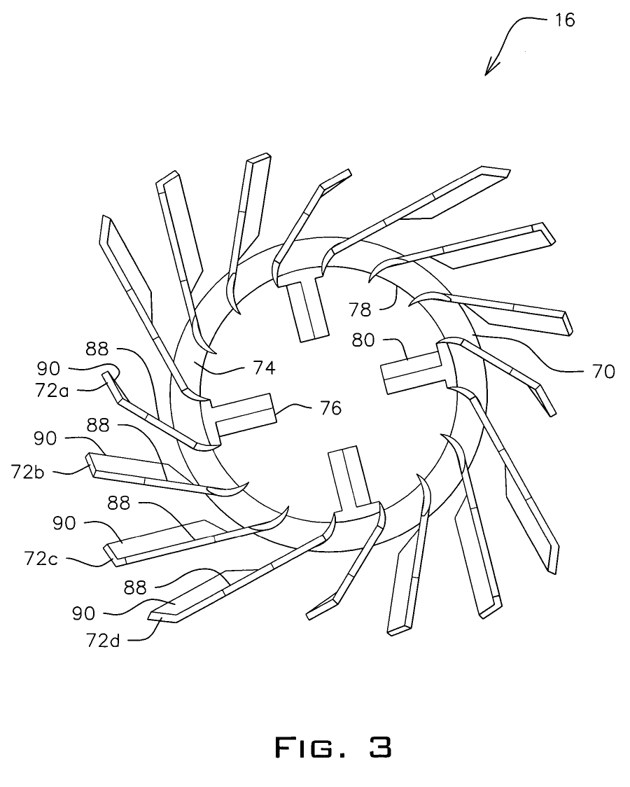

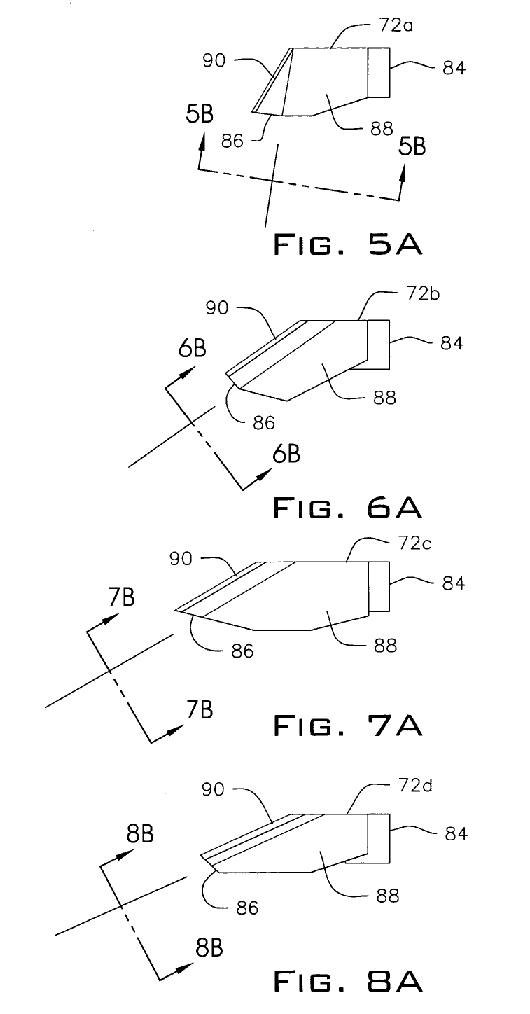

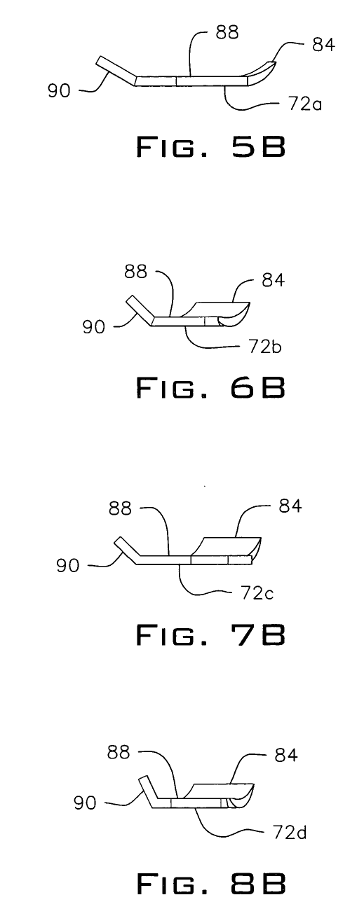

Referring now to FIGS. 3-8, the mounting ring 70 serves as a base or connector for the fins 72 and the guide tabs 76. The mounting ring 70 is preferably circularly shaped with an inner diameter greater than the outer diameter of the orifice housing 12 so that an inner peripheral side 78 is capable of being maintained in a non-contact relationship with the outer surface of the orifice housing 12 to eliminate undue interference with rotation of the turbine 16. The guide tabs 76 are sized and shaped to be positioned in the nozzle opening 50 between the first surface 22 of the orifice housing 12 and the second surface 44 of the deflector plate 14 so that the turbine 16 is freely rotatable between the first and second surfaces 22 and 44. The guide tabs 76 have a tapered leading edge 80 that facilitates the splitting of the fluid by the guide tabs 76 as the turbine 16 rotates about the nozzle opening 50. As such, a portion of the fluid in the nozzle opening 50 flows across the top of the guide tab 76 while another portion of the fluid flows across the bottom side of the guide tab 76. The flow of fluid across the guide tabs in this manner creates a fluid bearing on which the guide tabs 76 and in turn the turbine 16 rotate. The guide tabs 76 further function as a cleaning mechanism of any sludge or debris that attempts to build up in the nozzle opening 50. The turbine 16 has been illustrated as having four guide tabs 76. However, it will be appreciated by those of ordinary skill in the art that the number of guide tabs 76 utilized may be varied so long as the turbine 16 is maintained in a stable relationship with respect to the orifice housing 12 and the flow of fluid through the nozzle opening 50 is not significantly impeded. Each of the guide tabs 76 has an inner surface 82 which functions as a limit member. The inner surface 82 of the guide tabs 76 are engageable with the peripheral edge of the orifice housing 12 so as to maintain the turbine 16 in a substantially uniform relationship with respect to the orifice housing 12.

As best shown in FIGS. 3 and 4, the turbine 16, in one preferred embodiment has sixteen fins 72. The sixteen fins 72 are configured in four repeating sets about the turbine 16. Each set of fins includes fins 72a-72d, each of which is sized and configured to distribute fluid over various radial portions of the square spray pattern. That is, the fins 72-72d are not identically constructed. The fin 72a is designed to deflect fluid near the central area of the square spray pattern, the fin 72b to an intermediate area, and the fins 72c and 72d an outer perimeter area of the square spray pattern. The two fins 72c and 72d of the set of fins are utilized to deflect fluid to the outer perimeter area for the reason that the outer perimeter area encompasses more area than the central area of the square spray pattern, thereby resulting in a more uniform distribution of fluid over the square spray pattern. It will be understood that there can of course be overlap of fluid distribution of the various fins 72a-72d. Also, each of the fins 72a-72b contribute to deflecting fluid back and radially inward below the deflector plate 14 to eliminate a central void in the spray pattern below the deflector plate 14.

The fins 72 extend radially outward from the bottom surface 74 of the mounting ring 70 so that the fins 72 are positioned to intercept the fluid exiting the nozzle opening 50. Each of the fins 72 has a leading edge 84, a trailing edge 86, a radial surface 88 for directing the flow of fluid radially outward from the nozzle opening 50, and a vane 90 extending at an angle relative to the radial surface 88 so as to redirect the flow of fluid passing along the radial surface 88 of the fins 72. The direction and pattern that the fluid comes off each of the fins 72 is dependent on several factors. These factors include the length of the radial surface 88, the length of the vane 90, the angle of the vane 90 relative to a vertical plane, the angle of the vane 90 relative to a horizontal plane, and the angle at which fluid flows over the trailing edge 86.

In general, fluid exists the nozzle opening 50 and comes into contact with the fins 72. A portion of the fluid will contact the leading edge 84 which will deflect that portion of the fluid back and radially inward below the deflector plate 14. The remainder of the fluid will engage the radial surface 88 thereby applying a force to cause the turbine 16 to rotate. As the turbine 16 is rotating, the fluid will flow radially outward along the radial surface 88 until the fluid reaches the vane 90. The vane 90 of each fin 72 is generally angled in a downward and lateral direction to redirect the flow of fluid. As mentioned above, the direction that the fluid exits the fin 72 can be varied by altering the value of the factors listed above. In addition, the distribution of fluid can be further controlled by modifying the angle at which the fluid flows across the trailing edge 86 of the fins 72. More specifically, it has been found that as fluid flows across a surface, surface tension between the fluid and the surface maintains the fluid as a unit, but as the fluid flows off an edge of a surface the fluid will begin to fan or scatter. Thus, by modifying the angle of the trailing edge 86, the manner in which the fluid is distributed from the fin 72 can be controlled.

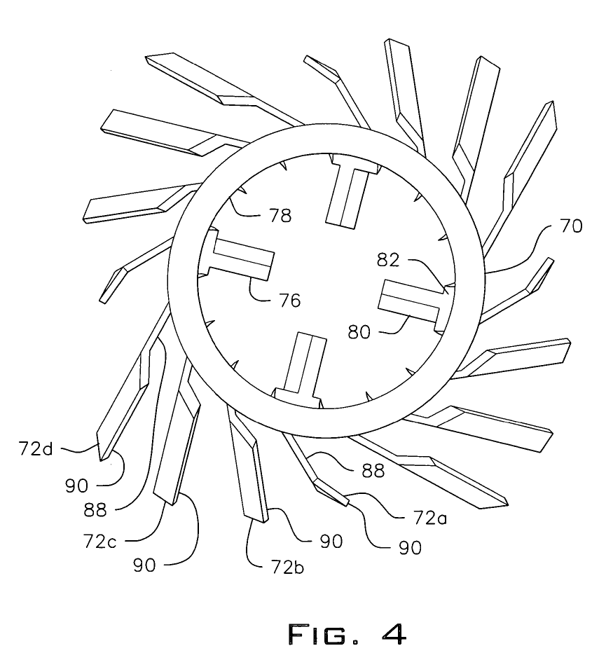

By way of example, the length of the radial surface 88 of fin 72a may be about 0.92 inches as measured along the top edge of the fin 72a from the leading edge 84 to the vane 90, the length of the vane 90 about 0.65 inches as measured along the intersection of the radial surface 88 and the vane 90, the angle of the vane 90 about 30 degrees as measured between the vane 90 and a vertical plane (FIG. 5B), the pitch of the vane 90 about 59 degrees as measured between the vane 90 and a horizontal plane (FIG. 5A), and the angle of the trailing edge 86 about 92 degrees as measured between the trailing edge 86 and the line formed by the intersection of the vane 90 and the radial surface 88. The length of the radial surface 88 of fin 72b may be about 0.51 inches, the length of the vane 90 about 1.13 inches, the angle of the vane 90 about 45 degrees, the pitch of the vane 90 about 36 degrees, and the angle of the trailing edge 86 about 96 degrees. The length of the radial surface 88 of fin 72c may be about 0.89 inches, the length of the vane 90 about 1.03 inches, the angle of the vane 90 about 45 degrees, the pitch of the vane 90 about 30 degrees, and the angle of the trailing edge 86 about 135. Finally, the length of the radial surface 88 of fin 72d may be about 0.62, the length of the vane 90 about 1.18, the angle of the vane 90 about 65 degrees, the pitch of the vane 90 about 24 degrees, and the angle of the trailing edge 86 about 112 degrees.

Although specific lengths and angles have been provided for each of the sixteen turbine fins 72, it should be appreciated by one of ordinary skill in the art that either the lengths or angles can be varied from the given values to fit or coincide with the particular application of the fluid distribution apparatus 10. As such, the specific values set forth hereinabove with respect to the lengths and angles of the sixteen fins 72 should not be regarded as limiting and other angles and lengths which accomplish the goal of dispersing fluid from the fluid distributing apparatus 10 in a square pattern and at a substantially constant volume across the entirety of the substrate are contemplated for use and as being a part of the invention claimed and disclosed herein.

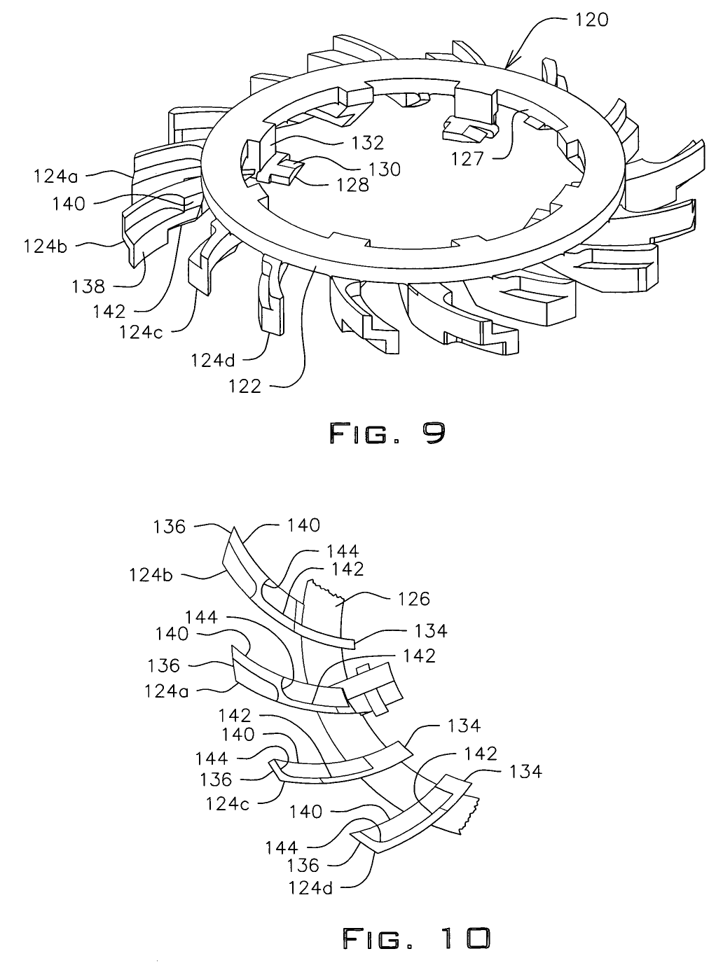

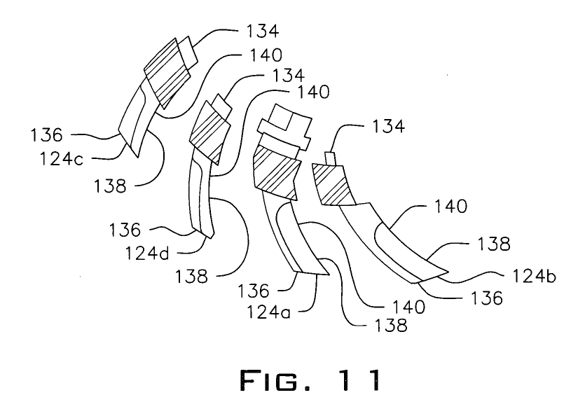

Referring now to FIGS. 9-11, another embodiment of a turbine 120 is illustrated. The turbine 120 includes a mounting ring 122 sized to be positioned about the orifice housing 12, a plurality of fins 124 extending circumferentially about a bottom surface 126 of the mounting ring 122, and a plurality of guide tabs 128 extending radially inwardly of the mounting ring 122 for maintaining the fins 124 in an operable relationship with the nozzle opening 50.

The mounting ring 122 serves as a base or connector for the fins 124 and the guide tabs 128. The mounting ring 122 is preferably circularly shaped with an inner diameter greater than the outer diameter of the orifice housing 12 so that an inner peripheral side 127 is capable of being maintained in a non-contact relationship with the outer surface of the orifice housing 12 to eliminate undue interference with rotation of the turbine 120. The guide tabs 128 are sized and shaped to be positioned in the nozzle opening 50 between the first surface 22 of the orifice housing 12 and the second surface 44 of the deflector plate 14 so that the turbine 120 is freely rotatable between the first and second surfaces 22 and 44. The guide tabs 128 have a tapered leading edge 130 that facilitates the splitting of the fluid by the guide tabs 128 as the turbine 120 rotates about the nozzle opening 50. As such, a portion of the fluid in the nozzle opening 50 flows across the top of the guide tab 128 while another portion of the fluid flows across the bottom side of the guide tab 128. The flow of fluid across the guide tabs 128 in this manner creates a fluid bearing on which the guide tabs 128 and in turn the turbine 120 rotate. The guide tabs 128 further function as a cleaning mechanism of any sludge or debris that attempts to build up in the nozzle opening 50. The turbine 120 has been illustrated as having four guide tabs 128. However, it will be appreciated by those of ordinary skill in the art that the number of guide tabs 128 utilized may be varied so long as the turbine 120 is maintained in a stable relationship with respect to the orifice housing 12 and the flow of fluid through the nozzle opening 50 is not significantly impeded. Each of the guide tabs 128 has an inner surface 132 which functions as a limit member. The inner surface 132 of the guide tabs 128 are engageable with the peripheral edge of the orifice housing 12 so as to maintain the turbine 120 in a substantially uniform relationship with respect to the orifice housing 12.

The turbine 120, in one preferred embodiment has sixteen fins 124. The sixteen fins 124 are configured in four repeating sets about the turbine 120. Each set of fins includes fins 124a-124d, each of which is sized and configured to distribute fluid over various portions of the square spray pattern. That is, the fins 124a-124d are not identically constructed. The fin 124a is designed to deflect fluid near the central area of the square spray pattern, the fin 124b to an intermediate area, and the fins 124c and 124d an outer perimeter area of the square spray pattern. The two fins 124c and 124d of the set of fins are utilized to deflect fluid to the outer perimeter area for the reason that the outer perimeter area encompasses more area than the central area of the square spray pattern. It will be understood that there can of course be overlap of fluid distribution of the various fins 124a-124d. Also, each of the fins 124a-124d will contribute to deflecting fluid back and radially inward below the deflector plate 14 to eliminate a central void in the spray pattern below the deflector plate 14.

The fins 124 extend radially outward from the bottom surface 126 of the mounting ring 122 so that the fins 124 are positioned to intercept the fluid exiting the nozzle opening 50. Each of the fins 124 has a leading edge 134, a trailing edge 136, and a radial surface 138 for directing the flow of fluid radially outward from the nozzle opening 50. The radial surface 138 is configured to having an upper section 140 and a lower section 142. The lower section 142 of the radial surface 138 is formed so as to be offset laterally from the upper section 140. The fins 124 are supported relative to the nozzle opening 50 so that the boundary between the upper section 140 and the lower section 142 substantially bisects nozzle opening 50 so that a portion of the fluid exiting the nozzle opening 50 flows across the upper section 140 and a portion of the fluid flows across the lower section 142. The lower section 142 has a configuration that is different than the configuration of the upper section 140 such that the upper section 140 and lower section 142 of the fins 124 direct fluid exiting the nozzle opening 50 in different directions.

In particular, the lower section 142 of the radial surface 138 is formed to have a vane 144 extending at an angle relative to radial surface 138 of the lower section 142 so as to redirect the flow of fluid passing along the lower section 142. Again, the direction and pattern that the fluid comes off each of the fins 124a-124d is dependent on several factors. These factors include the angle of the leading edge 134, the length of the radial surface 138, the position of the vane 144 along the length of the radial surface 138, and the angle of the vane 144.

In general, fluid exists the nozzle opening 50 and comes into contact with the fins 124. A portion of the fluid will contact the leading edge 134 which will deflect that portion of the fluid back and radially inward below the deflector plate 14. The angle of the leading edge 134 of the fins 124a-124d is shown to be different for each of the fins 124a-124d. The remainder of the fluid will engage the radial surface 138 of the upper section 140 and the lower section 142 thereby applying a force to cause the turbine 120 to rotate. As the turbine 16 is rotating, the fluid will flow radially outward along the radial surface 138 of the upper section 140 and the lower section 142. With respect to the lower section 142, the fluid will come into contact with the vane 144 which is generally oriented tangentially to the radial surface 138. As such, the vane 144 will function as a splash plate breaking up the flow of fluid. Where the spray of fluid falls along the radius of the spray pattern is dependent again on the location of the vane 144 along the length of the radial surface 138 and the angle of the vane 144. With respect to the upper section 140, the length of the radial surface 138 will be the primary factor in determining where the fluid falls along the radius of the spray pattern.

By way of example, the length of the upper section 140 of the upper section 140 of the radial surface 138 of the fin 124a may be about 1.56 inches, the length of the lower section 142 of the radial surface 138 about 0.90 inches, and the radius of the vane 144 about 0.15 inches. The length of the upper section 140 of the radial surface 138 of fin 124b may be about 1.35 inches, the length of the lower section 142 of the radial surface 138 about 0.62 inches, and the radius of the vane 144 about 0.15 inches. The length of the upper section 140 of the radial surface 138 of fin 124c may be about 1.40 inches, the length of the lower section 142 of the radial surface 138 about 1.16 inches, and the radius of the vane 144 about 0.18 inches. The length of the upper section 140 of the radial surface 138 of fin 124d may be about 1.25 inches, the length of the lower section 142 of the radial surface 138 about 0.95 inches, and the radius of the vane 144 about 0.18 inches.

Although specific lengths and angles have been provided for each of the sixteen turbine fins 124, it should be appreciated by one of ordinary skill in the art that either the lengths or angles can be varied from the given values to fit or coincide with the particular application of the fluid distribution apparatus 10. As such, the specific values set forth hereinabove with respect to the lengths and angles of the sixteen fins 124 should not be regarded as limiting and other angles and lengths which accomplish the goal of dispersing fluid from the fluid distributing apparatus 10 in a square pattern and at a substantially constant volume across the entirety of the substrate are contemplated for use and as being a part of the invention claimed and disclosed herein.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. In a fluid distributing apparatus of the type having a first surface and a second surface spaced apart from one another to define an annular nozzle opening therebetween, the first surface being an irregular surface shaped so that a spacing between the first and second surfaces varies around a circumference of the annular nozzle opening to create a non-circular spray pattern of fluid exiting the nozzle opening, and a rotatable turbine located between the first and second surfaces and freely movable between the first and second surfaces, the turbine a plurality of radially extending fins each having a leading edge, a trailing edge, and a radial surface for directing the flow of fluid exiting the nozzle opening, the improvement comprising:
at least a first one of the fins having a vane extending at an angle relative to the radial surface so as to redirect the flow of fluid passing along the radial surface of the fin.

2. The improvement of claim 1 wherein the trailing edge of the first fin extends at an angle relative to a longitudinal axis of the vane so that the flow of fluid across the trailing edge is at an acute angle relative to the trailing edge.

3. The improvement of claim 2 wherein the angle of the trailing edge of the first fin is different than the angle of the trailing edge of an adjacent fin.

4. The improvement of claim 1 wherein the angle between the vane and the radial surface of the first fin is different than the angle between the vane and the radial surface of an adjacent fin.

5. The improvement of claim 1 further comprising:
means for resiliently biasing the second surface toward the first surface to allow the spacing between the first and second surfaces to increase in response to an increase in fluid pressure in the annular nozzle opening, the biasing means being isolated from the fluid flowing through and from the fluid distributing apparatus.

6. A fluid distributing apparatus, comprising:
a orifice housing defining a first surface;
a deflector plate defining a second surface, the deflector plate connected to the orifice housing such that the first surface of the orifice housing and the second surface of the deflector plate are spaced apart from one another to define an annular nozzle opening therebetween; and
a turbine located between the first and second surfaces and freely rotatable between the first and second surfaces, the turbine having a plurality of radially extending fins each having leading edge, a trailing edge, and a radial surface for directing the flow of fluid exiting the nozzle opening, at least a first one of the fins having a vane extending at an angle relative to the radial surface so as to redirect the flow of fluid passing along the radial surface of the fin.

7. The fluid distributing apparatus of claim 6 wherein the trailing edge of the first fin extends at an angle relative to a longitudinal axis of the vane so that the flow of fluid across the trailing edge is at an acute angle relative to the trailing edge.

8. The fluid distributing apparatus of claim 7 wherein the angle of the trailing edge of the first fin is different than the angle of the trailing edge of an adjacent fin.

9. The fluid distributing apparatus of claim 6 wherein the angle between the vane and the radial surface of the first fin is different than the angle between the vane and the radial surface of an adjacent fin.

10. The fluid distributing apparatus of claim 6 further comprising:
means for biasing the second surface toward the first surface to allow the spacing between the first and second surfaces to increase in response to an increase in fluid pressure in the annular nozzle opening, the biasing means being isolated from the fluid flowing through and from the fluid distributing apparatus.

11. The fluid distributing apparatus of claim 6 wherein the deflector plate is connected to the orifice housing so as to permit movement of the deflector plate relative to the orifice housing, wherein the fluid distributing apparatus further comprises a spring for resiliently biasing the second surface of the deflector plate toward the first surface of the orifice housing to allow the spacing between the first and second surfaces to increase in response to an increase in fluid pressure in the annular nozzle opening, and wherein the spring is enclosed in one of the orifice housing and the deflector plate to isolate the spring from the fluid flowing through and from the fluid distributing apparatus.

12. A fluid distributing apparatus, comprising:
a orifice housing defining a first surface;
a deflector plate defining a second surface, the deflector plate connected to the orifice housing such that the first surface of the orifice housing and the second surface of the deflector plate are spaced apart from one another to define an annular nozzle opening therebetween and such that deflector plate is able to move relative to the orifice housing; and
a turbine located between the first and second surfaces and freely rotatable between the first and second surfaces, the turbine having a plurality of radially extending fins each having a leading edge, a trailing edge, and a radial surface for directing the flow of fluid exiting the nozzle opening; and
a spring for resiliently biasing the second surface of the deflector plate toward the first surface of the orifice housing to allow the spacing between the first and second surfaces to increase in response to an increase in fluid pressure in the annular nozzle opening, the spring enclosed in one of the orifice housing and the deflector plate to isolate the spring from the fluid flowing through and from the fluid distributing apparatus.

13. In a fluid distributing apparatus of the type having a first surface and a second surface spaced apart from one another to define an annular nozzle opening therebetween, the first surface being an irregular surface shaped so that a spacing between the first and second surfaces varies around a circumference of the annular nozzle opening to create a non-circular spray pattern of fluid exiting the nozzle opening, and a rotatable turbine located between the first and second surfaces and freely movable between the first and second surfaces, the turbine having a plurality of radially extending fins each having a leading edge, a trailing edge, and a radial surface for directing the flow of fluid exiting the nozzle opening,, the improvement comprising:
the radial surface of at least a first fin having an upper section and a lower section, the upper section having a configuration that is different than a configuration of the lower section such that the upper section and lower section of the first fin direct fluid exiting the nozzle opening in different directions.

14. The improvement of claim 13 wherein the configuration of the upper section of the first fin is different than the configuration of an upper section of the fin of an adjacent fin.

15. The improvement of claim 13 wherein the configuration of the lower section of the first fin is different than the configuration of a lower section of the fin of an adjacent fin.

16. The improvement of claim 13 wherein the configuration of the upper section of the first fin is different than the configuration of an upper section of the fin of an adjacent fin, and wherein the configuration of the lower section of the first fin is different than the configuration of a lower section of the fin of an adjacent fin.

17. The improvement of claim 13 further comprising:
means for resiliently biasing the second surface toward the first surface to allow the spacing between the first and second surfaces to increase in response to an increase in fluid pressure in the annular nozzle opening, the biasing means being isolated from the fluid flowing through and from the fluid distributing apparatus.

18. A fluid distributing apparatus, comprising:
a orifice housing defining a first surface;
a deflector plate defining a second surface, the deflector plate connected to the orifice housing such that the first surface of the orifice housing and the second surface of the deflector plate are spaced apart from one another to define an annular nozzle opening therebetween; and
a turbine located between the first and second surfaces and freely rotatable between the first and second surfaces, the turbine having a plurality of radially extending fins each having a leading edge, a trailing edge, and a radial surface for directing the flow of fluid exiting the nozzle opening, the radial surface of at least a first one of the fins having an upper section and a lower section, the upper section having a configuration that is different than a configuration of the lower section such that the upper section and lower section of the first fin direct fluid exiting the nozzle opening in different directions.

19. The fluid distributing apparatus of claim 18 wherein the configuration of the upper section of the first fin is different than the configuration of an upper section of the fin of an adjacent fin.

20. The fluid distributing apparatus of claim 18 wherein the configuration of the lower section of the first fin is different than the configuration of a lower section of the fin of an adjacent fin.

21. The fluid distributing apparatus of claim 18 wherein the configuration of the upper section of the first fin is different than the configuration of an upper section of the fin of an adjacent fin, and wherein the configuration of the lower section of the first fin is different than the configuration of a lower section of the fin of an adjacent fin.

22. The fluid distributing apparatus of claim 18 further comprising:
means for resiliently biasing the second surface toward the first surface to allow the spacing between the first and second surfaces to increase in response to an increase in fluid pressure in the annular nozzle opening, the biasing means being isolated from the fluid flowing through and from the fluid distributing apparatus.

23. The fluid distributing apparatus of claim 18 wherein deflector plate is connected to the orifice housing so as to permit movement of the deflector plate relative to the orifice housing, wherein the fluid distributing apparatus further comprises a spring for resiliently biasing the second surface of the deflector plate toward the first surface of the orifice housing to allow the spacing between the first and second surfaces to increase in response to an increase in fluid pressure in the annular nozzle opening, and wherein the spring is enclosed in one of the orifice housing and the deflector plate to isolate the spring from the fluid flowing through and from the fluid distributing apparatus.
